(19) United States
(12) Patent Application Publication
(10) Pub. No.: US 2025/0010928 A1
(43) Pub. Date: Jan. 9, 2025

(54) SYSTEMS AND METHODS FOR A DYNAMIC QUADRUPED WITH TUNABLE, COMPLIANT LEGS

(71) Applicants: Daniel Aukes, Gilbert, AZ (US); Fuchen Chen, Mesa, AZ (US)

(72) Inventors: Daniel Aukes, Gilbert, AZ (US); Fuchen Chen, Mesa, AZ (US)

(73) Assignee: Arizona Board of Regents on Behalf of Arizona State University, Tempe, AZ (US)

(21) Appl. No.: 18/766,467

(22) Filed: Jul. 8, 2024

Related U.S. Application Data
(60) Provisional application No. 63/525,491, filed on Jul. 7, 2023.

(51) Int. Cl. B62D 57/032; B25J 3/04

(52) U.S. Cl. CPC B62D 57/032; B25J 3/04

(57) ABSTRACT

A robot includes four compliant, laminated fiberglass-composite legs that enable tuning passive parallel and series compliance of each leg. The legs of the robot are impactful on the performance of its locomotion for gaits like pronking and trotting, demonstrating the robot's potential for tuning and optimizing leg stiffness for niche and specialized applications.

### CROSS REFERENCE TO RELATED APPLICATIONS

This is a non-provisional application that claims benefit to U.S. Provisional Application Ser. No. 63/525,491 filed on Jul. 7, 2023, which is herein incorporated by reference in its entirety.

### GOVERNMENT SUPPORT

This invention was made with government support under 1944789 awarded by the National Science Foundation. The government has certain rights in the invention.

### FIELD

The present disclosure generally relates to quadroped robots, and in particular, to a system and associated methods for dynamic quadruped robots with tunable, compliant legs.

### BACKGROUND

Despite its numerous advantages, passive leg stiffness is not present in several notable quadruped robots; this may be because integrating passive springs adds complexity to design, tuning, and control steps. Although many quadrupeds demonstrate passive compliant legs and its associated performance, less research has focused on tuning passive leg stiffness for desired goals; this demands unique design features that are not typically included.

It is with these observations in mind, among others, that various aspects of the present disclosure were conceived and developed.

### BRIEF DESCRIPTION OF THE DRAWINGS

FIG. 1A is a photograph showing a quadruped robot with tunable, compliant legs; FIG. 1B is a simplified illustration showing a leg member without springs; FIG. 1C is a simplified illustration showing an unfolded leg member which can be made from a strip of laminated material with rigid layers forming the sections of the leg member and flexible layers forming the joints; FIG. 1D is a simplified illustration showing the leg with a series of spring members; and FIG. 1E is a simplified illustration showing the leg with another series of springs.

FIG. 2A is an illustration showing motion of a four-bar linkage of a leg of the robot; FIG. 2B is an illustration showing deformation of a series spring of the leg of FIG. 2A; FIG. 2C is an illustration showing deformation of a parallel spring of the leg of FIG. 2B; and FIG. 2D is a photograph showing the leg of the robot of FIG. 1.

FIG. 3A is a photograph showing an actuation module of the robot of FIG. 1; FIG. 3B is an illustration showing routing and components of the actuation module of FIG. 3A; FIGS. 3C and 3D are simplified illustrations showing the knee retraction before and after to decrease knee angle as the knee input pulley is in a first rotational direction Q; and FIGS. 3E and 3F are simplified illustrations showing the knee retraction before and after to increase the knee angle as the knee input pulley is in a second rotational direction R.

FIG. 4A shows photographs of a pronking sequence of the robot of FIG. 1; FIG. 4B shows a simulation of a pronking sequence of the robot of FIG. 1 that corresponds with the pronking sequence of FIG. 4A; FIG. 4C shows photographs of a trotting sequence of the robot of FIG. 1; and FIG. 4D shows a simulation of a trotting sequence of the robot of FIG. 1 that corresponds with the trotting sequence of FIG. 4C.

FIG. 5A is a photograph showing a first variant (S1) of a leg of the robot of FIG. 1; FIG. 5B is a photograph showing a second variant (S2) of a leg of the robot of FIG. 1; and FIG. 5C is a photograph showing a third variant (S3) of a leg of the robot of FIG. 1.

FIG. 6A is a photograph showing an experimental setup for measuring series and parallel stiffness of the leg of the robot of FIG. 1; FIG. 6B is a photograph showing the robot of FIG. 6A pushing the series spring; and FIG. 6C is a photograph showing the robot of FIG. 6A pushing the parallel spring.

FIG. 7 is a graphical representation showing a “series” stiffness profile of the legs.

FIG. 8 is a graphical representation showing a “parallel” stiffness profile of the legs.

FIG. 9 is a graphical representation showing average peak body height of the robot pronking with different leg variants at different frequencies.

FIG. 10 is a graphical representation showing average speed of the robot trotting with different leg variants at different frequencies.

FIG. 11 is a graphical representation showing cost of transport of the robot trotting with different leg variants at different frequencies; and

FIG. 12 is a simplified diagram showing an exemplary computing system for implementation of a controller of the robot of FIG. 1.

Corresponding reference characters indicate corresponding elements among the view of the drawings. The headings used in the figures do not limit the scope of the claims.

### DETAILED DESCRIPTION

The present disclosure is directed to development of affordable and accessible quadrupeds to facilitate study of how passive leg stiffness influences locomotion dynamics and performance. To facilitate the study of how passive leg stiffness influences locomotion dynamics and performance, an affordable and accessible 400 gram quadruped robot driven by tunable compliant laminate legs is developed, whose series and parallel stiffness can be easily adjusted; fabrication only takes 2.5 hours for all four legs. The robot can trot at 0.52 m/s or 4.4 body lengths per second with a 3.2 cost of transport. Through locomotion experiments in both the real world and simulation, the present disclosure demonstrates that legs with different stiffness have an obvious impact on the robot's average speed, cost of transport, and pronking height, making it a suitable platform for future improvement and study.

### I. Introduction

Passive leg stiffness has potential for tuning and optimizing quadrupedal locomotion capabilities. Through a variety of legged robots including but not limited to quadrupeds, researchers have demonstrated that properly tuned leg stiffness can improve stability, impact resistance, efficiency, peak power output, and payload capacity. Physical springs have superior energy storage efficiency and actuation bandwidth compared to electric motors mimicking compliance via control. They can also cut down system costs by alleviating power requirements and electro-mechanical complexity.

To address the gaps seen in the existing literature, the present disclosure focuses on techniques to simplify and streamline the process of integrating compliance into the legs. The position of actuators, transmissions, and supporting structures have been carefully selected to make legs and springs easily interchangeable. Affordability and fabrication time have remained a priority because these aspects increase accessibility of legged robots to researchers inside and outside the field of robotics, as well as promote more rapid experimentation with real devices.

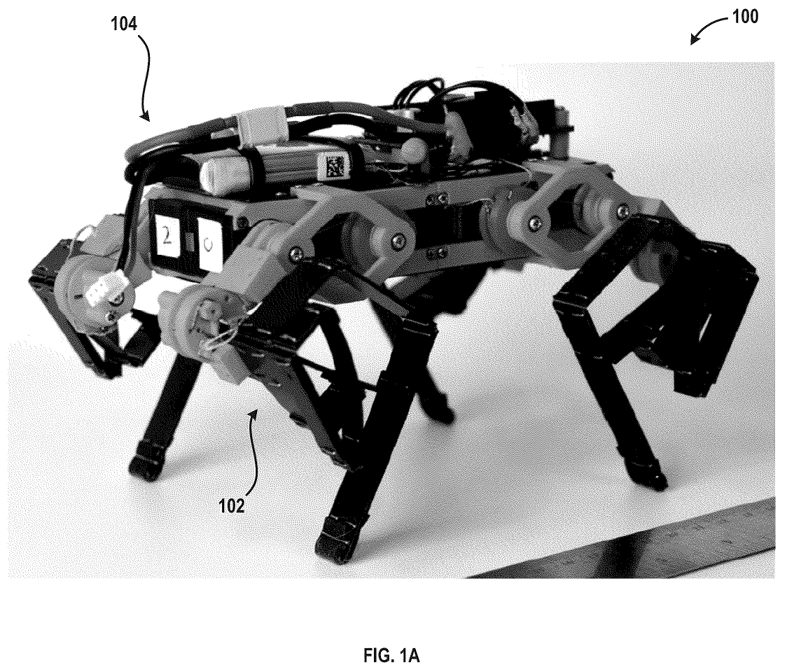

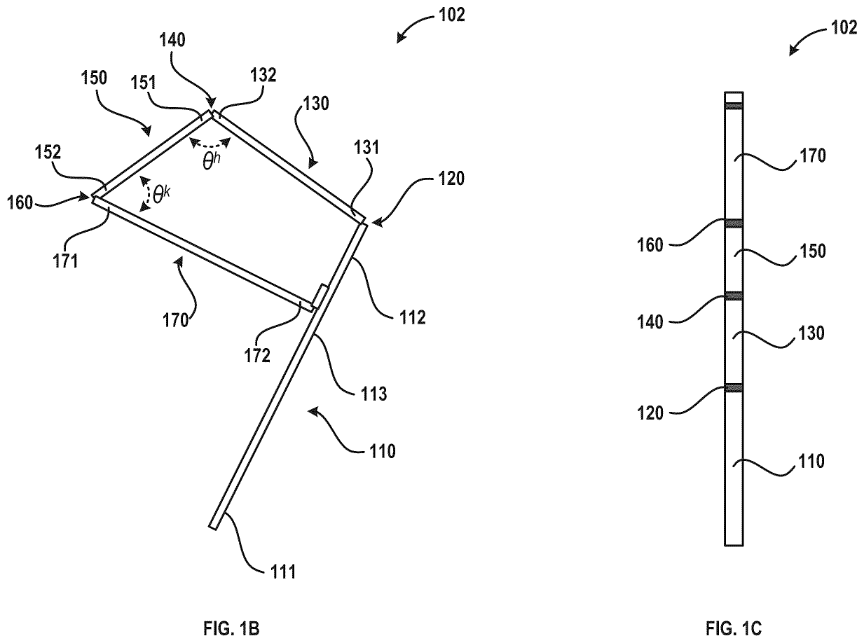

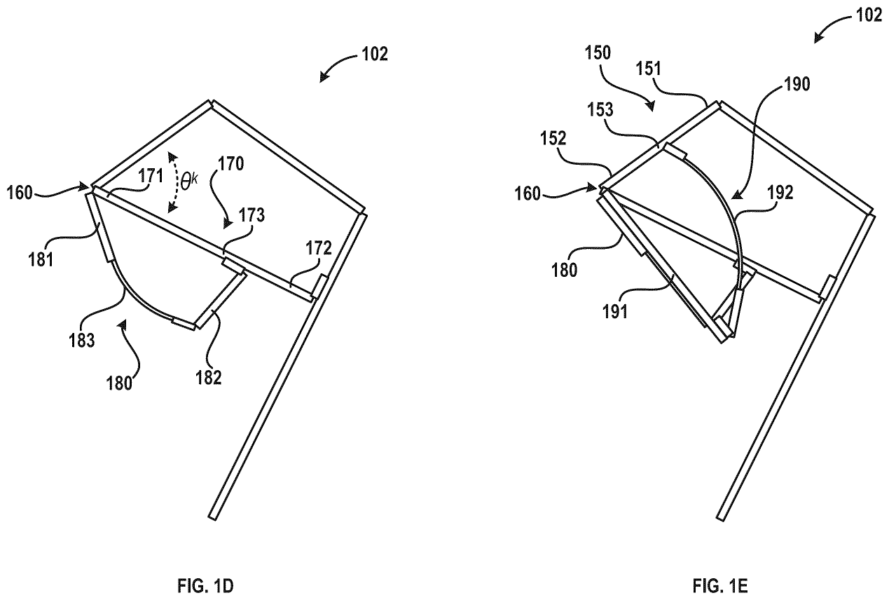

As shown in FIG. 1A, a robot 100 includes four 15 grams, finger-length legs 102. These compliant, laminated fiberglass-composite mechanisms are designed and fabricated to facilitate tuning the passive parallel and series compliance. The complete robot 100 has a footprint similar to an adult hand, weighs less than 400 grams, and is actuated by 8 servo motors. This disclosure aims to show that tuning passive leg stiffness of the robot 100 is not only straightforward and low-cost, but also impactful on the performance of its locomotion for gaits like pronking and trotting. This demonstrates potential for tuning and optimizing leg stiffness of the robot 100 for niche and specialized applications. A secondary aim is to demonstrate its agreement with a simulated environment, which will be useful for future design optimization and control algorithm development.

Compliant, laminate legs designed and fabricated with origami-inspired approaches can help address the above goals. The legs 102 shown in FIG. 1A may be fabricated as multi-layer, multi-material laminates that are cut, folded, and locked into three-dimensional mechanisms to provide both the desired kinematic motion and structural compliance. In this way, the tuning of the integrated system stiffness may be accomplished by adjusting the length, width, and thickness of key regions of the laminate system instead of relying on commercially available springs. This approach makes it possible to pack complex mechanisms within tight weight and size constraints. The fabrication time, material cost, and assembly difficulty is also significantly reduced in contrast with more conventional 3D printing, CNC machining, or other methods that utilize discrete parts—it takes 2.5 hours to make all four legs of the robot 100.

The contributions of this disclosure include: 1) a novel quadruped robot 100 designed for tunable, passive leg stiffness and 2) demonstrations of how tuning leg stiffness can impact the performance of quadrupedal locomotion in both real-world and simulated experiments. The disclosure is laid out as follows: First, the design of the robot 100 including the laminate legs and actuation modules is explained in section II. The gait generation and simulation environment for the robot 100 are then introduced in section III and section IV. Section V and section VI shows the measured stiffness profiles of three variants of the leg design; their impact on locomotion of the robot 100 is also unveiled with both experiments and simulation. Section VII concludes with thoughts on the future improvements and potential of this robot 100. Section VIII provides information about a computing system that may be used as a component of or in conjunction with a controller of the robot 100.

### II. Robot Design

As shown in FIG. 1A, the entire robot 100 includes four actuation modules of identical design, sandwiched by two fiberglass sheets, the top of which houses the microcontroller, sensor, and battery. Laminate legs 102 may be fabricated separately and attached to the modules.

### A. Legs

The leg 102 design includes three main components: a four-bar linkage responsible for extension and retraction, a laminate spring for providing series compliance, and a second spring for providing parallel compliance.

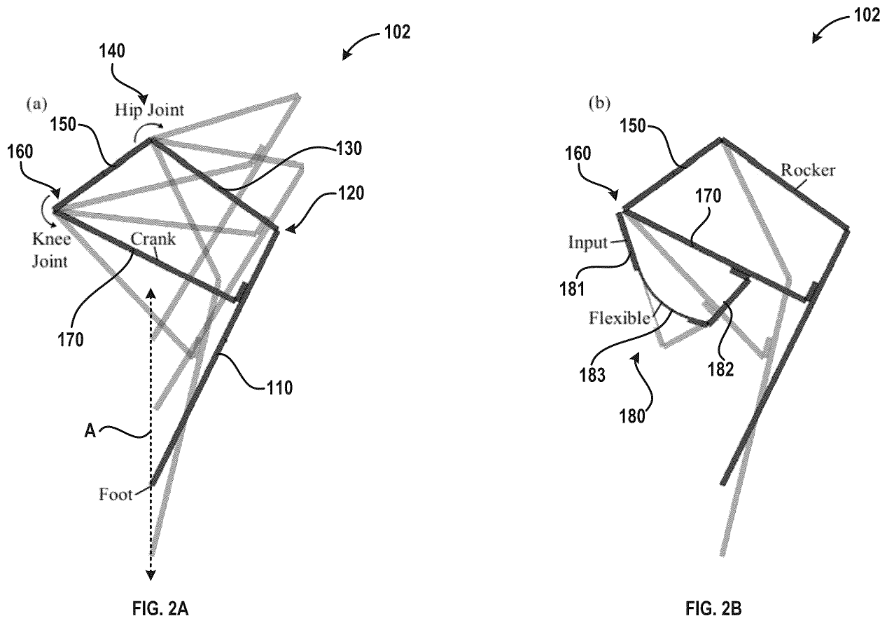

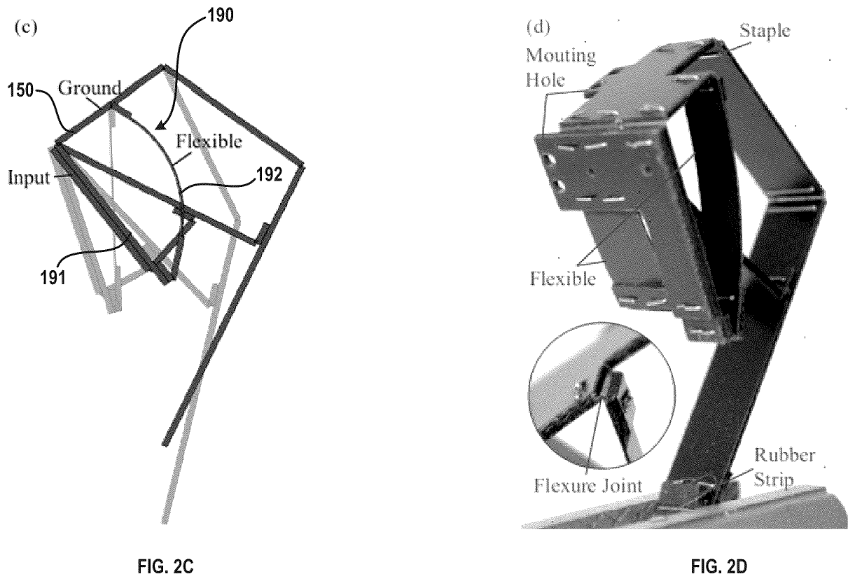

1) Four-bar Linkage: The main purpose of the four-bar linkage is to convert rotation into translation; its shape is optimized so that the foot fixed to its coupler link follows an approximated straight line when the crank is rotated, as illustrated in FIG. 2A. This design converts 1.16 rad rotation of the crank to a 6 cm change in effective leg length (distance between the hip joint and foot).

2) Laminate Springs: It is possible to fabricate torsion springs using folded laminate structures that result in a variety of stiffness profiles. The laminate spring design is composed of two rigid and one compliant links connected by flexure joints. Since one of the links is more flexible than the other two, the extra degree of freedom gained from that link's bending provides a restoring force under a torsional load, as illustrated in FIGS. 2B and 2C. The stiffness coefficient of the spring may then be related to the geometry of the flexible link.

As illustrated in FIG. 2B, the leg's series compliance is determined by a laminate spring attached to the crank of the four-bar linkage, whose input connects to the knee servo. In this way, if a force is exerted on the foot, the spring deforms before transmitting forces to the input link and vice versa to absorb external impacts. As illustrated in FIG. 2C, a second laminate spring is attached between the input and the ground links to provide parallel compliance. During retraction, the knee servo stores energy in this second spring that can be then released during extension to modulate power delivery from the servos. Although both springs exhibit compliance in one direction due to their joint limits, the range provided is sufficient for the purposes of this disclosure.

3) Fabrication: The leg member 102 includes five layers: a 0.72 mm fiberglass layer for structural rigidity, a 0.015 mm heat-activated adhesive layer, a 0.18 mm polyester sheet layer for flexure joints, another layer of the same adhesive, and a 0.45 mm fiberglass layer exposed selectively to soften the link. The leg member 102 is designed in Autodesk Fusion 360 in its flattened state, but the leg member 102 can be folded up as an assembly and attached to other components. Python scripts were used to convert the design into cut patterns. After all material layer patterns are laser-cut, the material layer patterns are stacked and laminated with a heat press machine. A final cut releases the device from the surrounding scrap. The leg member 102 is then folded and locked into place with common office staples; these are also added around joints to prevent delamination. A rubber strip may be attached to the foot to increase friction as shown in FIG. 2D.

### B. Actuation Module

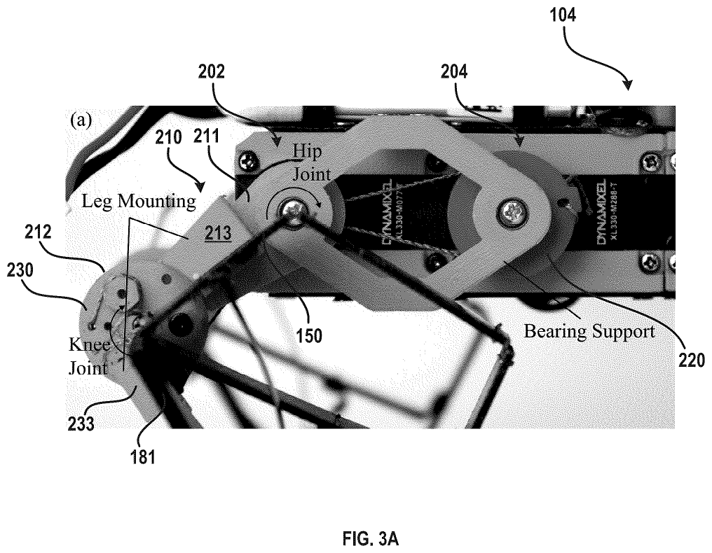

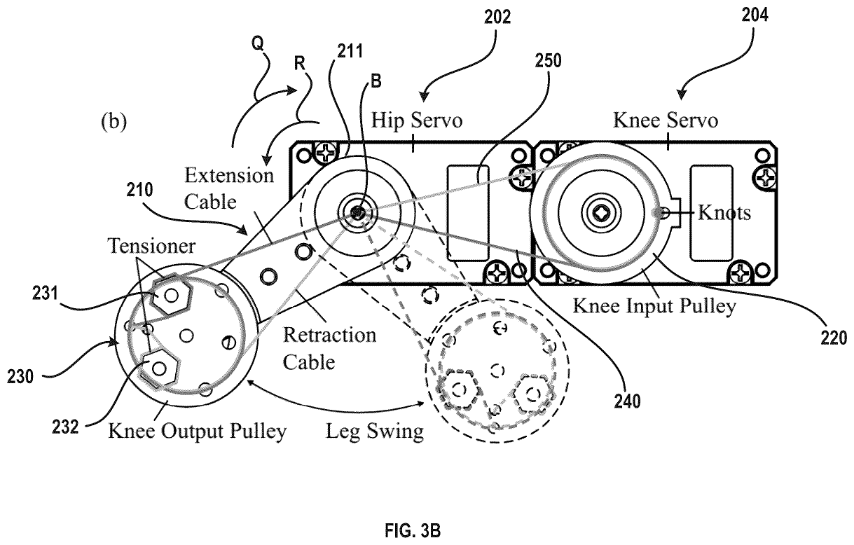

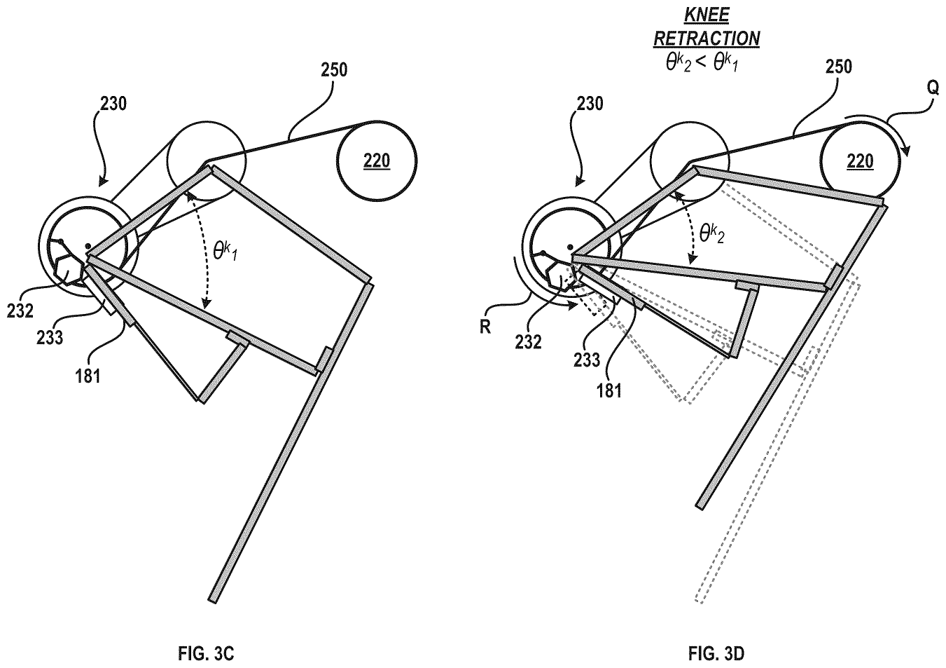

Two servo motors with identical form factors but different gear ratios were selected to actuate each leg as shown in FIG. 3. These servos are light-weight and compact at 18 grams each, feature-rich with various sensory feedback and customizable controllers, affordable, and easy to use. The higher-gear-ratio variant is used for the knee joint, since it needs to support most of the weight of the robot 100. The other motor swings the leg 102 about the hip joint. Instead of actuating a leg 102 in parallel, each leg's 102 motion was decoupled because it reduces the power loss due to geometric work, enables usage of different actuators, and allows independent passive stiffness along those axes. Leg 102 abduction and adduction motions were omitted to focus on the impact of passive stiffness in only the sagittal plane.

A cable-driven mechanism was employed to transmit the knee servo rotation to the knee joint, as illustrated in FIG. 3. Different from other existing designs, the two pulleys are separated from each other and the cables go through a tiny slot formed by two thin pins located at the hip joint to prevent the coupling between hip and knee angle. Despite the added assembly complexity and friction loss, this design avoids adding the knee servo's weight to the hip servo, keeping the total leg inertia minimal. It also allows locating the two servos next to each other to keep the footprint and body inertia of the robot 100 small. Mounting holes were added to the servo arm and output pulley so that each leg 102 could be attached to the module using only four screws. Most parts of the housing are 3D printed except the small bearings, cables, and screws.

### C. Operation and Structure

Referring to FIGS. 1A-1E, a device or robot 100, such as a quadruped, is disclosed herein. As noted above, the robot 100 includes a leg member 102 defining a four-bar linkage configuration and operatively connected to a hip servo motor 202 and a knee servo motor 204 with the leg member 102 including a coupler section 110 having a foot portion 111, a coupler hock portion 112 opposite from the foot portion 111, and a coupler midsection 113 between the foot portion 111 and the coupler hock portion 112. The robot 100 has a rocker section 130 that includes a rocker hock portion 131 and a rocker hip portion 132 in which the rocker hock portion 131 is pivotably coupled to the coupler hock portion 112 of the coupler section 110 at a hock joint 120. In addition, a ground section 150 includes a ground hip portion 151 and a ground knee portion 152 with the ground hip portion 151 being pivotably coupled to the rocker hip portion 132 of the rocker section 130 at a hip joint 140 that defines a hip angle on between the rocker section 130 and the ground section 150, and the ground section 150 being operatively connected to the hip servo motor 202. In addition, a crank section 170 includes a crank knee portion 171 and a distal connecting portion 172, the crank knee portion 171 being pivotably coupled to the ground section 150 at a knee joint 160 that defines a knee angle ok between the ground section 150 and the crank section 170, and the distal connecting portion 172 being coupled to the coupler midsection 113 of the coupler section 110; and a series spring 180 associated with the crank section 170 and having a series input portion 181 operatively connected to the knee servo motor 204. In particular, the knee servo motor 204 is operable for increasing or decreasing the knee angle independent of the hip angle and the hip servo motor 202 is operable for increasing or decreasing the hip angle independent of the knee angle.

In addition, the input portion of the series spring 180 is associated with the crank knee portion 171 of the crank section 170, wherein the series spring 180 further includes a flexible series portion 183 connected to the series input portion 181. A distal connecter portion 182 is coupled to a crank midsection 173 of the crank section 170 of the leg member 102, wherein the distal connecter portion 182 is pivotably coupled to the flexible portion at a series spring joint 184.

In one aspect, the flexible series portion 183 of the series spring 180 provides passive series compliance for the leg member 102.

In some embodiments, the robot 100 may include a parallel spring 190 associated with the series spring 180 and having a parallel input portion 191 coupled along the series input portion 181 of the series spring 180 and a flexible parallel portion 192 coupled to a ground midsection 153 of the ground section 150 of the leg member 102, wherein the flexible parallel portion 192 is pivotably coupled to the flexible portion at a series spring joint 184. The flexible parallel portion 192 of the parallel spring 190 provides passive parallel compliance for the leg member 102 and the leg member 102 is constructed from a single member having a rigid layer and a flexible layer.

As shown in FIGS. 1B and 1C, the rigid layer is divided into the coupler section 110, the rocker section 130, the ground section 150 and the crank section 170 of the leg member 102, while the flexible layer forms the hock joint 120 of the leg member 102 that links the coupler section 110 to the rocker section 130, the hip joint 140 of the leg member 102 which links the rocker section 130 to the ground section 150, while the knee joint 160 of the leg member 102 links the ground section 150 and the crank section 170 of the leg member 102.

As illustrated in FIG. 3D, the rotation of the knee servo motor 204 in a first rotational direction Q causes the series spring 180 to decrease the knee angle, and wherein rotation of the knee servo motor 204 in a second rotational direction R causes the series spring 180 to increase the knee angle such that rotation of the hip servo motor 202 in a first rotational direction Q causes the ground section 150 to increase the hip angle. Conversely, as shown in FIG. 3F rotation of the hip servo motor 202 in a second rotational direction R causes the ground spring to decrease the hip angle.

Referring to FIG. 2A, the foot of the coupler section 110 translates along a vertical line A upon rotation of the knee servo motor 204 and the hip servo motor 202 and the knee servo motor 204 are coupled to a body 104 of a robot 100.

In some embodiments, the leg member 102 is one of a plurality of identical leg members 102 of the robot 100. As such, the description herein regarding the leg member 102 applies equally to the other leg members 102.

Referring to FIG. 3B, the device 100 further includes a swinging member 210 coupled to the hip servo motor 202 with the swinging member 210 including a proximal swing portion 211 and a distal swing portion 212 having a leg mounting portion 213 between the proximal swing portion 211 and the distal swing portion 212. In particular, the proximal swing portion 211 of the swinging member 210 is operatively coupled to the hip servo motor 202 such that rotation of the hip servo motor 202 causes rotation of the distal swing portion 212 about an axis B defined by the hip servo motor 202, while the leg mounting portion 213 of the swinging member 210 is coupled to a ground midsection 153 of the ground section 150 of the leg member 102 for increasing the hip angle or decreasing the hip angle upon rotation of the hip servo motor 202; and the distal swing portion 212 of the swinging member 210 including a knee output pulley 230 that engages the series input portion 181 of the series spring 180 (FIG. 1D).

As shown in FIGS. 3A-3F, the robot 100 further includes a knee input pulley 220 rotatable by the knee servo motor 204, the knee input pulley 220 being operatively associated with a knee output pulley 230 positioned at the distal swing portion 212 of the swinging member 210 by a knee extension cable 240 and a knee retraction cable 250, wherein rotation of the knee input pulley 220 in a first rotational direction Q by the knee servo motor 204 causes the knee retraction cable 250 to rotate the knee output pulley 230 in a second rotational direction R, thereby causing the series spring 180 to decrease the knee angle; and wherein rotation of the knee input pulley 220 in a second rotational direction R by the knee servo motor 204 causes the knee extension cable 240 to rotate the knee output pulley 230 in a first rotational direction Q, thereby causing the series spring 180 to increase the knee angle, and wherein the hip joint 140 includes one or more slots for passage of the knee extension cable 240 and the knee retraction cable 250 to prevent coupling between the knee angle and the hip angle such that the hip angle is unaffected by the knee angle and the knee angle is unaffected by the hip angle, and wherein the knee output pulley 230 includes a knee extension tensioner element 231 and a knee retraction tensioner element 232, wherein the knee extension cable 240 wraps around the knee extension tensioner element 231 and wherein the knee retraction cable 250 wraps around the knee retraction tensioner element 232.

In one embodiment, the robot 100 shown in FIGS. 1A and 3A may include a plurality of leg members 102 coupled to a body 104, the body 104 including a hip servo motor 202 and a knee servo motor 204, each respective leg member 102 of the plurality of leg members 102 defining a four-bar linkage configuration and including a series spring 180 having a series input portion 181 operatively connected to the knee servo motor 204, wherein the knee servo motor 204 is operable for increasing or decreasing a knee angle θ^{k} of the leg member 102 independent of a hip angle θ^{h} of the leg member 102; and wherein the hip servo motor 202 is operable for increasing or decreasing the hip angle independent of the knee angle.

In some embodiments, each leg member 102 of the plurality of leg members 102 may include a coupler section 110 having a foot portion 111, a coupler hock portion 112 located opposite from the foot portion 111, and a coupler midsection 113 located between the foot portion 111 and the coupler hock portion 112. The rocker section 130 includes a rocker hock portion 131 and a rocker hip portion 132, wherein the rocker hock portion 131 is pivotably coupled to the coupler hock portion 112 of the coupler section 110 at a hock joint 120. In addition, a ground section 150 includes a ground hip portion 151 and a ground knee portion 152 in which the ground hip portion 151 is pivotably coupled to the rocker hip portion 132 of the rocker section 130 at a hip joint 140. The hip joint 140 defines the hip angle θ^{h} between the rocker section 130 and the ground section 150, while the ground section 150 is operatively connected to the hip servo motor 202. In addition, a crank section 170 includes a crank knee portion 171 and a distal connecting portion 172 with the crank knee portion 171 being pivotably coupled to the ground section 150 at a knee joint 160 that defines the knee angle θ^{k} between the ground section 150 and the crank section 170. The distal connecting portion 172 is coupled to the coupler midsection 113 of the coupler section 110. In some embodiments, the leg member 102 is constructed from a single member having a rigid layer and a flexible layer with the rigid layer being divided into the coupler section 110, the rocker section 130, the ground section 150 and the crank section 170 of the leg member 102. The flexible layer forms the hock joint 120 of the leg member 102 that links the coupler section 110 to the rocker section 130. In addition, the hip joint 140 of the leg member 102 links the rocker section 130 to the ground section 150, and the knee joint 160 of the leg member 102 links the ground section 150 and the crank section 170 of the leg member 102.

In some embodiments, the robot 100 may further include a swinging member 210 coupled to the hip servo motor 202 with the swinging member 210 including a proximal swing portion 211 and a distal swing portion 212 having a leg mounting portion 213 between the proximal swing portion 211 and the distal swing portion 212 as shown in FIG. 3B. The proximal swing portion 211 of the swinging member 210 is operatively coupled to the hip servo motor 202 such that rotation of the hip servo motor 202 causes rotation of the distal swing portion 212 about an axis B defined by the hip servo motor 202. In addition, the leg mounting portion 213 of the swinging member 210 is coupled to the leg member 102 for increasing the hip angle or decreasing the hip angle upon rotation of the hip servo motor 202 and the distal swing portion 212 of the swinging member 210 includes a knee output pulley 230 that engages the series input portion 181 of the series spring 180.

### III. Locomotion

Since the robot 100 has two passive degrees of freedom from the springs and no sensory feedback, an open-loop Central Pattern Generator (CPG) is selected for generating locomotory signals. CPGs are a group of coupled oscillators that generate rhythmic joint trajectories from non-rhythmic inputs; they were capable of generating a variety of gait patterns for locomotion that are independent of the system's dynamics.

The present implementation of the CPG includes four coupled oscillators described by the following differential equation:

$${\dot{ϕ}}_{i} = 2 π f + {\sum }_{j = 1}^{4} {α}_{ϕ} {c}_{i j} sin ( {ϕ}_{j} - {ϕ}_{i} - {ψ}_{ij} ) , \qquad ( 1 )$$

where f is the gait frequency, α_{ϕ}=1 is a constant controlling the convergence rate, and i or j from 1 to 4 represents the oscillator related to the front left (FL), front right (FR), rear left (RL), and rear right (RR) leg respectively. cᵢⱼ is an element from the matrix c describing the coupling strength between oscillators and

$${c}_{i j} = \{ \begin{matrix}0 , i = j \\ 1 , i = j\end{matrix} \cdot {ψ}_{i j}$$

is an element from the matrix ψ describing the desired phase difference between oscillators and the values for the pronking and trotting gait used in the experiments are:

$${ψ}_{pronk} = 0 , {ψ}_{trot} = [ \begin{matrix}0 & - π & - π & 0 \\ π & 0 & 0 & π \\ π & 0 & 0 & π \\ 0 & - π & - π & 0\end{matrix} ]$$

The phase of each oscillator, wrapped into [0, 2π), was then converted to its respective hip joint angle with:

$${θ}_{i}^{h} = {a}_{i}^{h} cos ( {ϕ}_{i}^{h} ) + {o}_{i}^{h} , \qquad ( 2 )$$

$${ϕ}_{i}^{h} = \{ \begin{matrix}\frac{{ϕ}_{i}}{2 d} , & {ϕ}_{i} < 2 π d , \\ \frac{{ϕ}_{i} - 2 π d}{2 ( 1 - d )} + π , & otherwise\end{matrix} \qquad ( 3 )$$

where d indicates the duty factor or percentage of the stance duration over one cycle, aᵢ^{h} is the hip swing amplitude, and oᵢ^{h} is the hip swing offset. The knee angle was also calculated from the oscillator's phase with:

$${θ}_{i}^{k} = {a}_{i}^{k} {ϕ}_{i}^{k} + {o}_{i}^{k} , \qquad ( 4 )$$

$${ϕ}_{i}^{k} = \{ \begin{matrix}1 , & 2 π ( d + {o}_{r} ( 1 - d ) ) < {ϕ}_{i} < 2 π , \\ 0 , & otherwise\end{matrix} \qquad ( 5 )$$

where aᵢ^{k} is the knee retraction amplitude, oᵢ^{k} is the knee retraction offset, and oᵣ is the knee retraction timing offset in percentage of the flight duration. Although the input knee angle behaves like a step function, the actual knee angle will be smoothed by the spring and motor dynamics. In the formulation, the hip angle is positive when swinging forward and the knee angle is positive when retracting.

A first-order differential equation is used to relate the desired CPG parameter value p_{d} with the actual value p∈{f, d, oᵣ, aᵢ^{h}, aᵢ^{k}, oᵢ^{h}, oᵢ^{k}} for smooth transition between different gaits as in:

$$\dot{p} = {α}_{p} ( {p}_{d} - p ) , \qquad ( 6 )$$

where αₚ=10 to keep the settling time within a second. The CPG is implemented and runs at 100 Hz on the microcontroller and its output values are fed into the servos running their default PID angle control.

### IV. Simulation

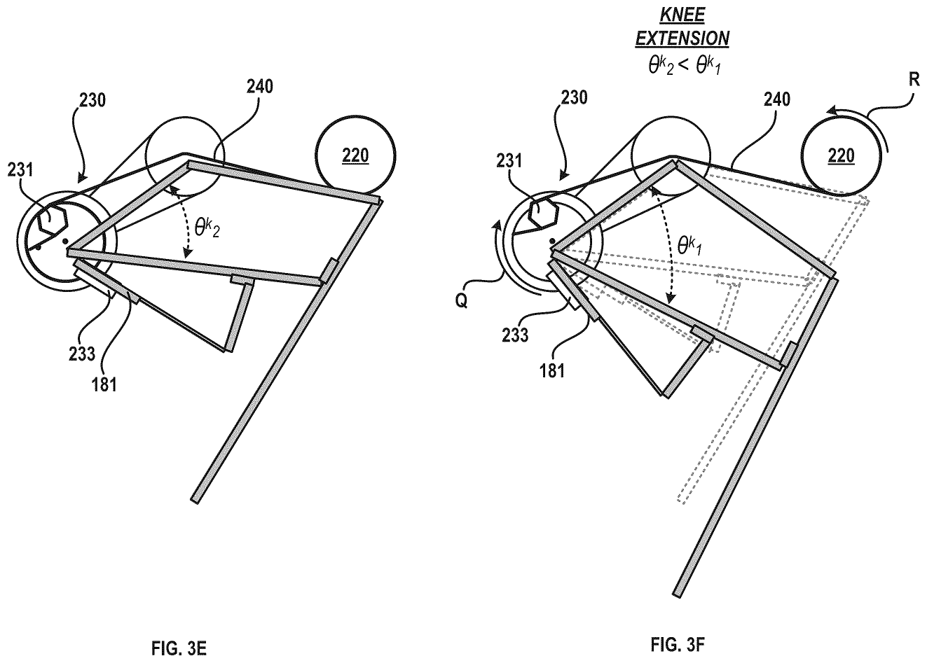

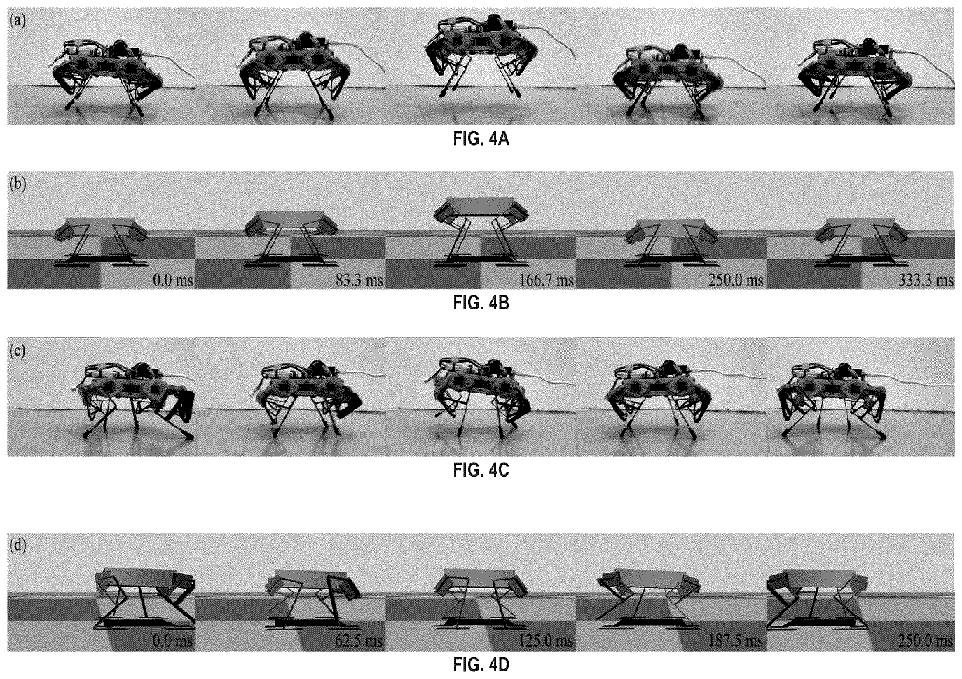

A physics-based simulation environment was developed in MuJoCo and Python, as shown in FIGS. 4B and 4D, to demonstrate that the behavior of the robot 100 with passive leg stiffness can be modeled with similar approaches using existing tools. For each leg 102, the four-bar linkage was represented as rigid boxes connected with pin joints; the two types of compliance were treated as torsional springs at the knee joint 160. The dynamics of the entire servo including its motor, gearbox, and internal controller were modelled as an inertia-spring-damper system, which takes a desired angle as the input and outputs a torque. A maximum output torque constraint and static friction within the motor was also added. Additional boxes are added to match the mass and inertia of various parts of the robot 100. MuJoCo's default contact model was used for the simulation. The CPG was also implemented in simulation to control a virtual representation of the robot 100.

### V. Experiments

To validate that the platform was suitable for studying passive leg 102 stiffness in quadrupedal locomotion, a suite of experiments was undertaken to evaluate the tunability of the passive leg 102 stiffness, its effect on performance of the robot 100 under two gaits (pronking and trotting), and the feasibility of a simulation environment.

### A. Stiffness Tunability

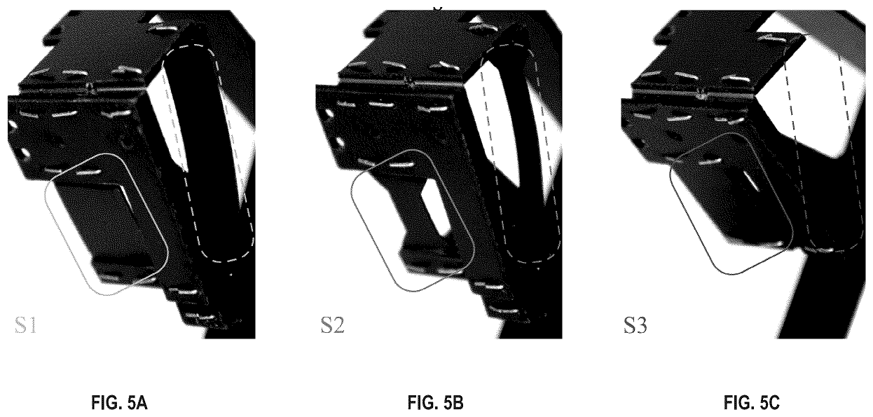

Three variants of the leg 102 were designed, as shown in FIGS. 5A-5C; leg S1 uses a baseline shape and dimension; for leg S2, the width of both the series and parallel springs are reduced by half; in leg S3 the parallel spring is completely removed and the thickness of the series spring is the same as the rest of the laminate's.

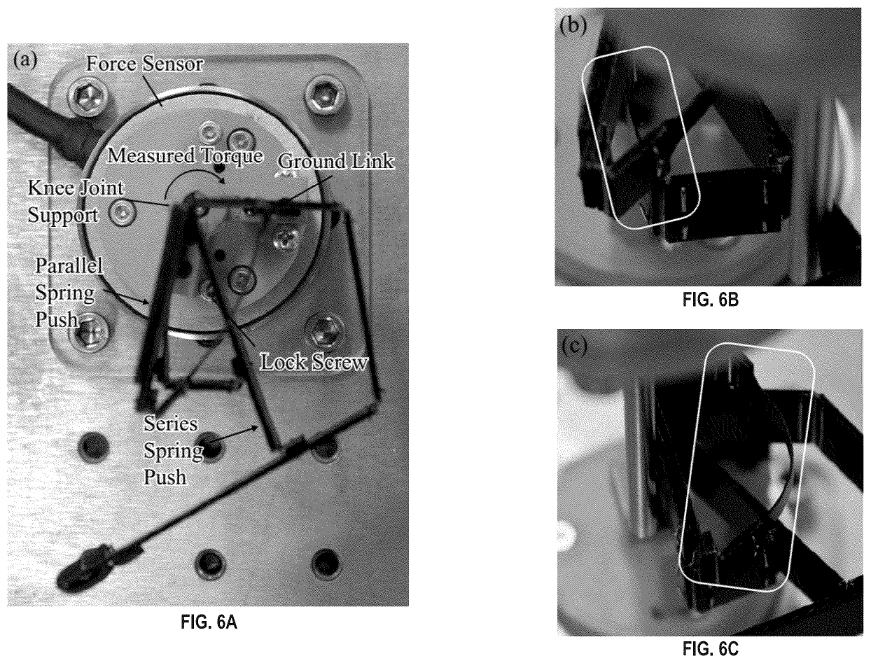

Four samples were fabricated for each leg 102 variant. For each sample, its torque-deformation curve was measured using a static loading setup as shown in FIGS. 6A-6C. The leg 102 was attached to a force sensor with a 3D printed jig that only allows knee rotation of the leg 102. To measure parallel stiffness, the leg's 102 input link was pushed by a robot 100 arm around the knee joint 160 to only deform the parallel spring 190. To measure series stiffness, the input link is locked with a screw and the robot 100 arm pushes the crank of the four-bar linkage to deform only the series spring 180. For both procedures, the robot 100 is commanded to step 0.01 rad every 1.5 seconds until a maximum deformation range is reached, which is conservatively chosen to avoid damaging the leg 102 or sensor. For each step, only the settled section of the force readings was used. The starting point of the spring's deformation is where the torque first exceeds 0.005 Nm. Three trials are performed for each sample and the data are interpolated and averaged to get the stiffness curve.

### B. Pronking

A pronking (jumping with all leg members 102 at the same time) experiment was carried out to verify the impact of tuning the leg 102 stiffness. For each leg variant, all four samples are first attached to the robot 100 and all servo angles are calibrated to make sure the home pose of the robot 100 stays the same. Then, the robot 100 is commanded to pronk in place from rest at various frequencies with the CPG parameter values listed in Table I on a level, flat, hard, metal surface. An example of a pronking cycle is shown in FIG. 4A. The duration of each run is 20 seconds, 10 seconds, 6.67 seconds, and 5 seconds for 1 Hz, 2 Hz, 3 Hz and 4 Hz, respectively, so that the number of gait cycles are roughly the same. A USB cable is attached to the rear of the robot 100 for data collection but is kept slack for the entire process. Three trials were carried out per frequency per leg 102 variant. A motion capture system was used to record body pose data of the robot 100 at 100 Hz.

### C. Trotting

A series of trotting runs was also performed to confirm that tuning the leg stiffness of the robot 100 affects its running performance. For each leg variant, after the setup procedure similar to the pronking experiment, the robot 100 is commanded to trot forward from standing still at various frequencies with the CPG parameter values listed in Table I on a level, flat, hard, and slightly textured surface. At each frequency, most parameters are kept the same except the retraction offset timing oᵣ whose value requires adjustment to stabilize the gait. An example trotting cycle is shown in FIG. 4C. The duration of each run and number of trials follow the pronking experiment. Since the motion capture area is not big enough, a tape measure is used to determine the distance between starting and ending positions of the robot 100, which is then divided by the duration of the run to get the average speed. The current through each servo is also recorded at 100 Hz. Given that the supplied voltage is 5V, the average power consumption p can be derived and the cost of transport (COT) computed as

$$C O T = \frac{P}{m g v} where m = 0.396 kg , g = 9.81 m / {s}^{2} ,$$

and v is the average speed.

### D. Simulation

The same pronking and trotting experiments were performed in simulation and the same performance metrics were recorded. Only one trial per frequency was carried out because the model is deterministic. The power term used in the COT calculation is the average positive mechanical power output by all the servos; this is different from the experiment because the electrical power consumption was not computed in the simulation.

All the parameter values for the servos are identified by matching the frequency response of a separate MuJoCo model to a set of experiments that swing the servos with increasing frequency with various loads. The friction coefficient is set to 0.39 for both gaits. This value was determined by dragging the robot 100 with a force gauge on the experimental surfaces. Since the damping properties of the leg's springs are unknown, a differential evolution minimization routine using Python's SciPy package was selected to minimize the percentage error of the average velocity and peak height between simulation and experimentation to determine the proper damping coefficients for each leg variant.

### VI. Results and Discussions

### A. Stiffness Tunability

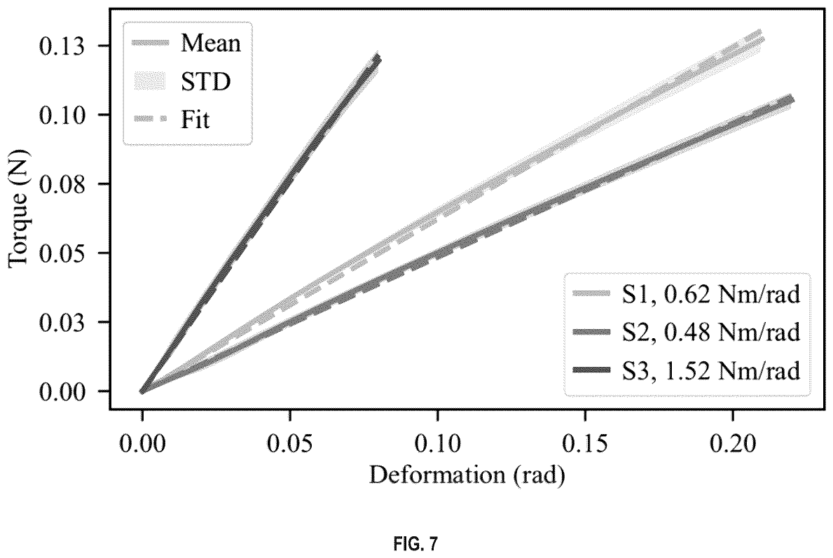

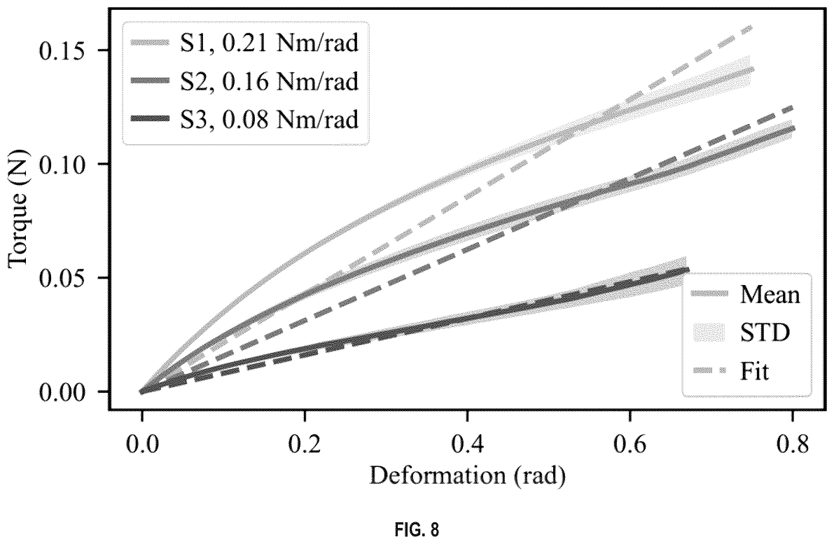

The measured series and parallel stiffness profiles of all the leg variants are plotted in FIG. 7 and FIG. 8; these figures highlight how series and parallel compliance can be easily tuned in the leg design. The data across different fabricated samples of the same variant also show consistent mechanical properties with low variation. Regarding linearity, the series spring exhibited nearly linear stiffness, which was expected since it follows the previous design, where linearity was controlled via the geometry. On the other hand, the parallel spring, which is new to this work, showed initially stiffer behavior at smaller deflections. Whether this nonlinearity is desirable or not for quadrupedal locomotion remains an open and interesting research question. Counterintuitively, the S3 leg's stiffness profile is relatively similar to the other two legs S1/S2, even though it has no specific flexible sections. Further investigation indicates that the measured series stiffness is inherent in the structure due to the relatively thin laminates used, while the parallel stiffness measured can be attributed to the stiffness of the mechanisms' flexure joints.

### B. Pronking

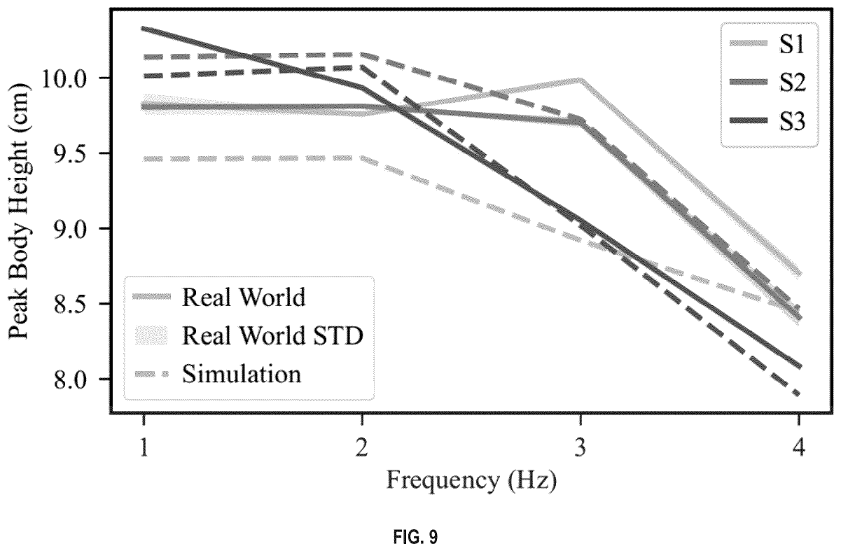

The average peak body height of the pronking experiment is plotted in FIG. 9. In some implementations, it was found that power of the servos of the robot 100 is not always enough to produce a significant height increase. At 1 Hz, the feet of the robot 100 does not leave the ground and the peak body height equals the standing height. It should be noted that the standing height of the robot 100 is slightly different for each leg 102 variant due to varying leg 102 stiffness. For most cases, the servos cannot keep up with the increasing frequency and the actual knee output amplitude drops, resulting in a height loss. However, the stiffness of the S1 leg manages to resonate at the 3 Hz frequency, achieving a small but noticeable height gain. This demonstrates how tuning leg stiffness can achieve better pronking performance.

### C. Trotting

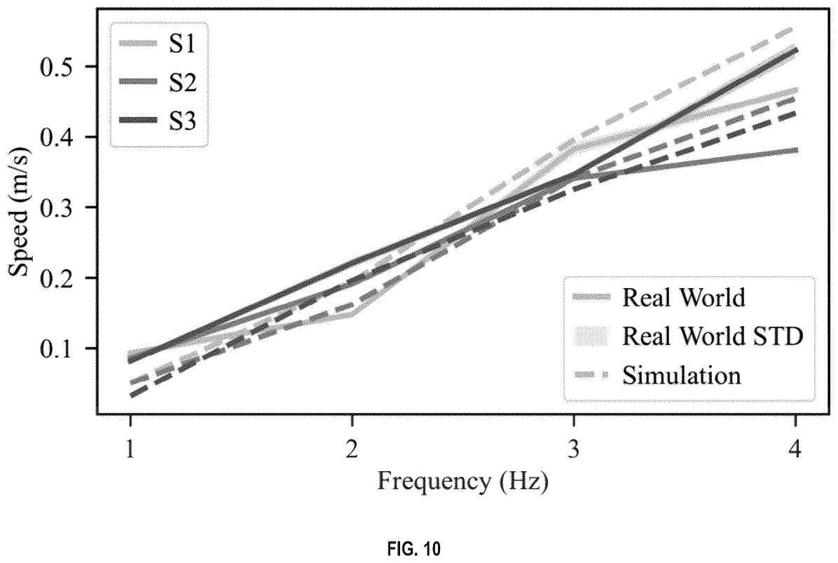

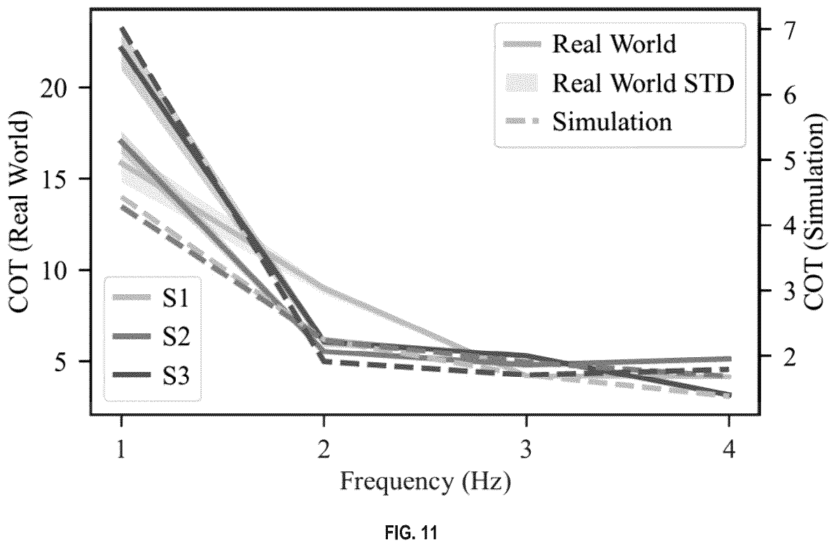

The average speed and COT of the trotting experiment was plotted in FIGS. 10 and 11. A near linear increase in speed was observed; this was expected since the amplitude of the leg's swing is equivalent across all frequencies while the flight phase remains short. A maximum speed around 0.52 m/s is achieved, equivalent to 4.4 body lengths per second, where a body length is the distance between the front and rear hip joints of the robot 100. The smallest measured COT was 3.2. Interestingly, the best performing leg 102 in terms of speed or efficiency changes as a function of frequency, indicating that the optimum passive leg stiffness varies for quadruped robots 100 intended to trot at different frequencies or speeds.

### D. Simulation

The simulation results are plotted alongside the real-world results in FIGS. 9-11 and the average percentage error of the average trotting speed and pronking peak height is 12.7%. The general trends of the pronking and trotting performance match well but the best performing legs at some frequencies differ from the real-world experiments; this is probably due to the inaccuracy of the contact model, the absence of the cable-driven mechanism model, and the “parasitic” compliance of the supposedly rigid laminate links. With further tweaking and calibration, the simulation environment is expected to represent the robot 100 better and contribute to future study.

### VII. Conclusions

The design of the (quadruped) robot 100 with compliant laminate legs 102 has been presented in detail, along with initial results that demonstrate the potential for varying passive leg stiffness for tuning pronking and trotting performance. Future work will continue to improve the design of the robot 100 to widen the range of achievable leg stiffness and locomotion capabilities, while maintaining a focus on affordable and accessible design approaches. Using this platform, many potential research questions can be explored, such as how to develop control algorithms that can identify and exploit variable, passive leg stiffness, and the role of parallel and series compliance in tuning different gaits across various locomotion metrics. This platform has the potential to increase accessibility to legged robotic locomotion, with potential applications in education, agriculture, and other applications in which tunability, simplicity, and affordability remain constraints.

### Computer-Implemented System

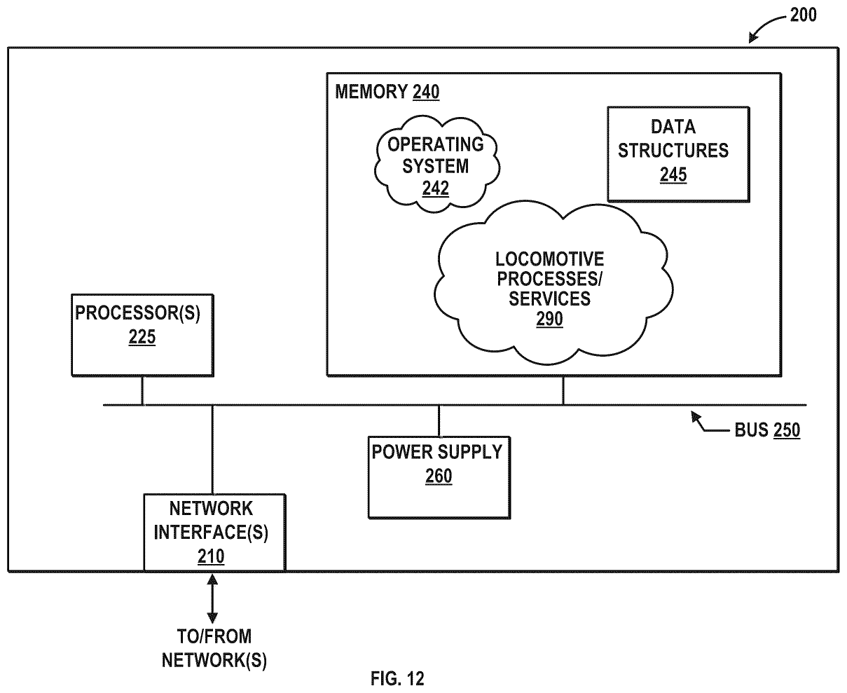

FIG. 12 is a schematic block diagram of an example device 200 that may be used with one or more embodiments described herein, e.g., as a component of robot 100 shown in FIG. 1.

Device 200 comprises one or more network interfaces 210 (e.g., wired, wireless, PLC, etc.), at least one processor 225, and a memory 240 interconnected by a system bus 250, as well as a power supply 260 (e.g., battery, plug-in, etc.).

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 includes a plurality of storage locations that are addressable by processor 225 and network interfaces 210 for storing software programs and data structures associated with the embodiments described herein. In some embodiments, device 200 may have limited memory or no memory (e.g., no memory for storage other than for programs/processes operating on the device and associated caches). Memory 240 can include instructions executable by the processor 225 that, when executed by the processor 225, cause the processor 225 to implement aspects of the robot 100 and the methods outlined herein.

Processor 225 comprises hardware elements or logic adapted to execute the software programs (e.g., instructions) and manipulate data structures 245. An operating system 242, portions of which are typically resident in memory 240 and executed by the processor 225, functionally organizes device 200 by, inter alia, invoking operations in support of software processes and/or services executing on the device. These software processes and/or services may include locomotive processes/services 290, which can include aspects of methods and/or implementations of various modules described herein. Note that while locomotive processes/services 290 is illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the locomotive processes/services 290 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A device, comprising:
a leg member defining a four-bar linkage configuration and operatively connected to a hip servo motor and a knee servo motor, the leg member including:
a coupler section having a foot portion, a coupler hock portion opposite from the foot portion, and a coupler midsection between the foot portion and the coupler hock portion;
a rocker section having a rocker hock portion and a rocker hip portion, the rocker hock portion being pivotably coupled to the coupler hock portion of the coupler section at a hock joint;
a ground section having a ground hip portion and a ground knee portion, the ground hip portion being pivotably coupled to the rocker hip portion of the rocker section at a hip joint that defines a hip angle θ^{h} between the rocker section and the ground section, and the ground section being operatively connected to the hip servo motor; and
a crank section having a crank knee portion and a distal connecting portion, the crank knee portion being pivotably coupled to the ground section at a knee joint that defines a knee angle θ^{k} between the ground section and the crank section, and the distal connecting portion being coupled to the coupler midsection of the coupler section; and
a series spring associated with the crank section and having a series input portion operatively connected to the knee servo motor;
wherein the knee servo motor is operable for increasing or decreasing the knee angle independent of the hip angle; and
wherein the hip servo motor s operable for increasing or decreasing the hip angle independent of the knee angle.

2. The device of claim 1, the input portion of the series spring being associated with the crank knee portion of the crank section.

3. The device of claim 1, the series spring further including:
a flexible series portion connected to the series input portion; and
a distal connecter portion coupled to a crank midsection of the crank section of the leg member, the distal connecter portion being pivotably coupled to the flexible portion at a series spring joint.

4. The device of claim 3, wherein the flexible series portion of the series spring provides passive series compliance for the leg member.

5. The device of claim 1, further comprising:
a parallel spring associated with the series spring and having a parallel input portion coupled along the series input portion of the series spring and a flexible parallel portion coupled to a ground midsection of the ground section of the leg member, the flexible parallel portion being pivotably coupled to the flexible portion at a series spring joint.

6. The device of claim 5, wherein the flexible parallel portion of the parallel spring 190 provides passive parallel compliance for the leg member.

7. The device of claim 1, wherein the leg member is constructed from a single member having a rigid layer and a flexible layer,
the rigid layer being divided into the coupler section, the rocker section, the ground section and the crank section of the leg member; and
the flexible layer forming the hock joint of the leg member that links the coupler section to the rocker section, the hip joint of the leg member that links the rocker section to the ground section, and the knee joint of the leg member that links the ground section and the crank section of the leg member.

8. The device of claim 1, wherein rotation of the knee servo motor in a first rotational direction Q causes the series spring to decrease the knee angle, and wherein rotation of the knee servo motor in a second rotational direction R causes the series spring to increase the knee angle.

9. The device of claim 1, wherein rotation of the hip servo motor in a first rotational direction Q causes the ground section to increase the hip angle, and wherein rotation of the hip servo motor in a second rotational direction R causes the ground spring to decrease the hip angle.

10. The device of claim 1, wherein the foot of the coupler section translates along a substantially vertical line A upon rotation of the knee servo motor.

11. The device of claim 1, wherein the hip servo motor and the knee servo motor are coupled to a body of a robot.

12. The device of claim 11, wherein the leg member is one of a plurality of leg members of the robot.

13. The device of claim 1, further comprising:
a swinging member coupled to the hip servo motor, the swinging member including a proximal swing portion and a distal swing portion having a leg mounting portion between the proximal swing portion and the distal swing portion;
the proximal swing portion of the swinging member being operatively coupled to the hip servo motor such that rotation of the hip servo motor causes rotation of the distal swing portion about an axis B defined by the hip servo motor;
the leg mounting portion of the swinging member being coupled to a ground midsection of the ground section of the leg member for increasing the hip angle or decreasing the hip angle upon rotation of the hip servo motor; and
the distal swing portion of the swinging member including a knee output pulley that engages the series input portion of the series spring.

14. The device of claim 13, further comprising:
a knee input pulley rotatable by the knee servo motor, the knee input pulley being operatively associated with a knee output pulley positioned at the distal swing portion of the swinging member by a knee extension cable and a knee retraction cable;
wherein rotation of the knee input pulley in a first rotational direction Q by the knee servo motor causes the knee retraction cable to rotate the knee output pulley in a second rotational direction R, thereby causing the series spring to decrease the knee angle; and
wherein rotation of the knee input pulley in a second rotational direction R by the knee servo motor causes the knee extension cable to rotate the knee output pulley in a first rotational direction Q, thereby causing the series spring to increase the knee angle.

15. The device of claim 14, wherein the hip joint includes one or more slots for passage of the knee extension cable and the knee retraction cable to prevent coupling between the knee angle and the hip angle such that the hip angle is unaffected by the knee angle and the knee angle is unaffected by the hip angle.

16. The device of claim 14, wherein the knee output pulley includes a knee extension tensioner element and a knee retraction tensioner element, wherein the knee extension cable wraps around the knee extension tensioner element and wherein the knee retraction cable wraps around the knee retraction tensioner element.

17. A robot, comprising:
a plurality of leg members coupled to a body, the body including a hip servo motor and a knee servo motor;
each respective leg member of the plurality of leg members defining a four-bar linkage configuration and including a series spring having a series input portion operatively connected to the knee servo motor;
wherein the knee servo motor is operable for increasing or decreasing a knee angle θ^{k} of the leg member independent of a hip angle θ^{h} of the leg member; and
wherein the hip servo motor is operable for increasing or decreasing the hip angle independent of the knee angle.

18. The robot of claim 17, each leg member of the plurality of leg members including:
a coupler section having a foot portion, a coupler hock portion opposite from the foot portion, and a coupler midsection between the foot portion and the coupler hock portion;
a rocker section having a rocker hock portion and a rocker hip portion, the rocker hock portion being pivotably coupled to the coupler hock portion of the coupler section at a hock joint;
a ground section having a ground hip portion and a ground knee portion, the ground hip portion being pivotably coupled to the rocker hip portion of the rocker section at a hip joint that defines the hip angle θ^{h} between the rocker section and the ground section, and the ground section being operatively connected to the hip servo motor;
a crank section having a crank knee portion and a distal connecting portion, the crank knee portion being pivotably coupled to the ground section at a knee joint that defines the knee angle θ^{k} between the ground section and the crank section, and the distal connecting portion being coupled to the coupler midsection of the coupler section.

19. The robot of claim 18, wherein the leg member is constructed from a single member having a rigid layer and a flexible layer;
the rigid layer being divided into the coupler section, the rocker section, the ground section and the crank section of the leg member; and
the flexible layer forming the hock joint of the leg member that links the coupler section to the rocker section, the hip joint of the leg member that links the rocker section to the ground section, and the knee joint of the leg member that links the ground section and the crank section of the leg member.

20. The robot of claim 17, further comprising:
a swinging member coupled to the hip servo motor, the swinging member including a proximal swing portion and a distal swing portion having a leg mounting portion between the proximal swing portion and the distal swing portion;
the proximal swing portion of the swinging member being operatively coupled to the hip servo motor such that rotation of the hip servo motor causes rotation of the distal swing portion about an axis B defined by the hip servo motor;
the leg mounting portion of the swinging member being coupled to the leg member for increasing the hip angle or decreasing the hip angle upon rotation of the hip servo motor; and
the distal swing portion of the swinging member including a knee output pulley that engages the series input portion of the series spring.
